(19) United States
(12) Patent Application Publication
(10) Pub. No.: US 2006/0009234 A1
(43) Pub. Date: Jan. 12, 2006

(54) Portable electronic device

(75) Inventor: Carl Johan Freer, Bordon (GB)

Correspondence Address: FOGG AND ASSOCIATES, LLC, P.O. BOX 581339, MINNEAPOLIS, MN, 55458-1339, US

(73) Assignee: Tiger Telematics, Inc., Jacksonville, FL (US)

(21) Appl. No.: 10/945,271

(22) Filed: Sep. 20, 2004

(30) Foreign Application Priority Data
Jul. 9, 2004 (GB) 0415447.2

(51) Int. Cl. H04Q 7/20; H04M 11/04

(52) U.S. Cl. 455/456.1; 455/404.2; 455/457

(57) ABSTRACT

A portable electronic device has a user interface having a display and an entertainment system which outputs entertainment media signals to the user interface. A tracking system generates tracking data from signals received from Global Positioning System satellites and a monitoring system processes the tracking data to obtain monitoring data which includes at least position data for the device. A wireless communications system communicating with a cellular network transmits the monitoring data to a control centre and receives map data representative of an area corresponding to the position of the device. A mapping module processes the map data to generate display data for indicating the device position.

### BACKGROUND OF THE INVENTION

This application claims priority from United Kingdom Patent Application 0415447.2 filed Jul. 9, 2004, which is incorporated herein by reference.

### FIELD OF THE INVENTION

This invention relates to a portable electronic device with a facility for generating tracking data, and to a system in which the device user is monitored using the tracking data. Further aspects of the invention relate to providing advertising messages.

### DESCRIPTION OF THE RELATED ART

It is known for portable electronic devices to be provided with circuits responsive to signals from Global Positioning System (GPS) Satellites for determining the position of the device, the GPS data being used for navigation purposes. It is also known from U.S. Pat. No. 6,320,495 for the GPS data to be wirelessly transmitted to a remote terminal as input to a computer program operated game.

It is also known from U.S. Pat. No. 6,579,184B1 for multi-player video games to be provided by a number of electronic devices which communicate via a cellular wireless network such as GSM.

There is a need in a variety of circumstances to provide a facility for monitoring the current location of a person, either out of interest or out of reasons of responsibility by another person, referred to herein as a guardian user. The reasons for monitoring may be as simple as wishing to maintain social contact, or exercising responsibility as a guardian, or exercising legal responsibility where the guardian user is required to keep track of the movements of the device user.

### SUMMARY OF THE INVENTION

According to the present invention, a system for use in location monitoring comprises a portable electronic device for being carried by the device user. The device has a multifunctional entertainment system for providing entertainment functions of interest to the device user. An embodiment includes a game console as well as other multimedia functions, thereby providing a varied and comprehensive source of entertainment which the device user will regard as being indispensable and therefore carry as a matter of routine and without coercion.

The device includes a position measuring system for generating tracking data and has a wireless communications capability for communicating monitoring data to be remotely accessed by the guardian user. The monitoring data may include not only position data but other information including alarms generated manually by the device user actuating an alarm button or generated automatically by the device as a result of processing the tracking data and applying predetermined alarm criteria.

The device also may be provided with a means for delivering advertising messages to be presented via a user interface of the device.

### THE DRAWINGS

Embodiments of the invention will now be described by way of example only and with reference to the accompanying drawings of which:

FIG. 1 is a schematic overview of a system including a portable electronic device for use in location monitoring;

FIG. 2 is an external view of the device of FIG. 1;

FIG. 3 is a schematic diagram illustrating hardware components of the device;

FIG. 4 is a schematic diagram illustrating software components of the device;

FIG. 5 is a flowchart illustrating operating steps in a method of using the system of FIG. 1.

FIG. 6 is a schematic diagram of monitoring data;

FIG. 7 is a schematic diagram of a display screen presented either on the screen of the device or at a remote terminal;

FIG. 8 is a further display screen illustrating setting of a boundary.

FIG. 9 is a schematic diagram illustrating a map data provider and advertising message provider;

FIG. 10 is a schematic diagram of an advertising message provider;

FIG. 11 is a flowchart illustrating display of a received message;

FIG. 12 is a schematic diagram illustrating use of a secure digital card to obtain media files;

FIG. 13 is a schematic flowchart illustrating the display of map data in response to actuation of the user interface and the manner in which configuring data may be updated by direct access to the device;

FIG. 14 is an external view of an alternative embodiment;

FIG. 15 is a flowchart of a method of providing advertisement messages;

FIG. 16 is a schematic diagram of a point of sale checkout scanning a barcode displayed on the device; and

FIG. 17 is a schematic flowchart of a method of receiving and managing advertising messages.

### DETAILED DESCRIPTION

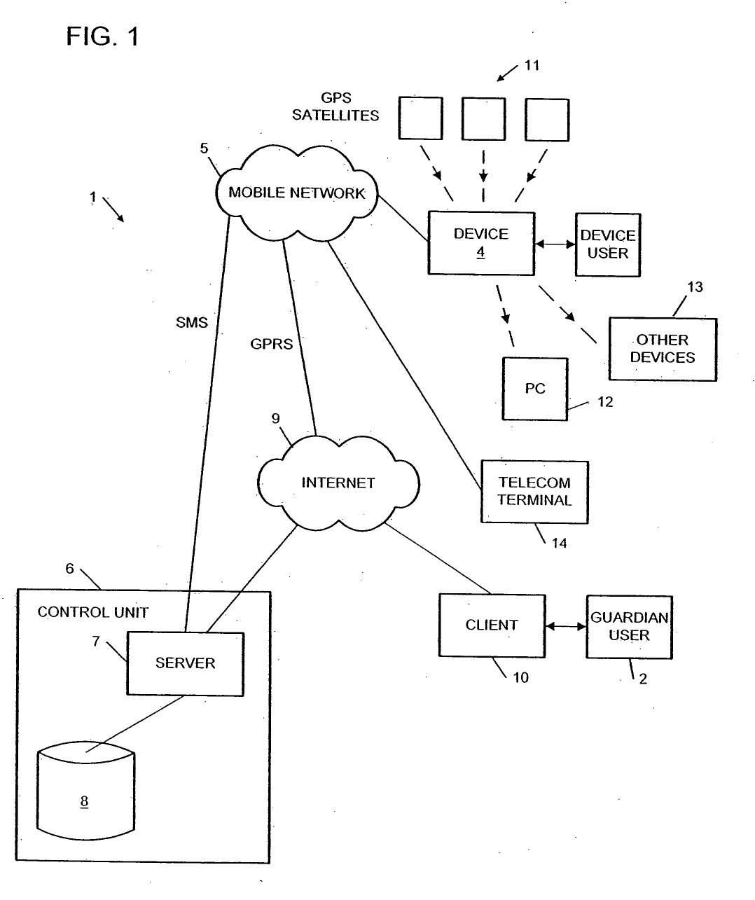

FIG. 1 illustrates a monitoring system 1 for enabling a guardian user 2 to monitor a device user 3. A portable electronic device 4 is carried by the device user 3 in order for the device user to utilise entertainment functions available from the device.

The device 4 is capable of wireless communication via a mobile network 5 with a control unit 6 for communicating monitoring data to and for receiving communications from the control unit. The control unit 6 comprises a server 7 with access to a database 8, the server having connection to the internet 9 for communication with a client computer 10 accessible to the guardian user 2 and for providing an additional channel of communication with the device via an internet gateway of the network 5.

The device 4 is responsive to wireless signals from satellites 11 of a GPS system enabling the device to generate tracking data comprising position data and, when moving, speed and heading data.

The system 1 of this embodiment comprises primarily the device 4, the control unit 6 and client computer 10. Additional connection may periodically or optionally be made to further components illustrated in FIG. 1, as for example a personal computer 12 which may be locally connected to the device 4 for the exchange of programs or data, further such devices 13 which may interact with the device 4 during multiplayer game use, and telecommunications terminals 14 capable of communicating with the device via the mobile network 5.

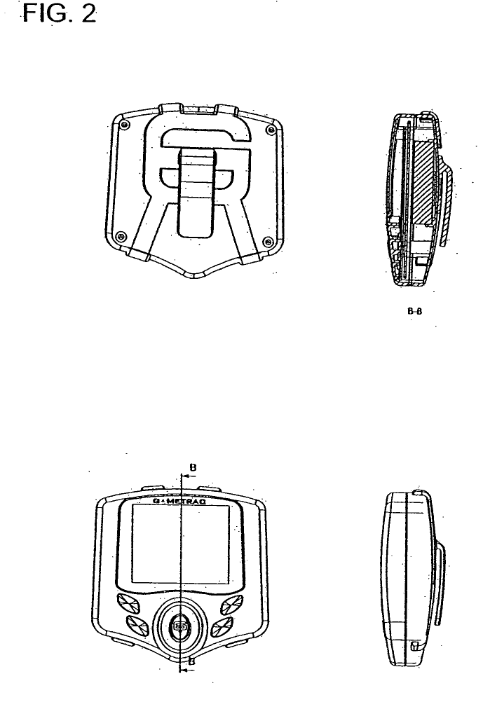

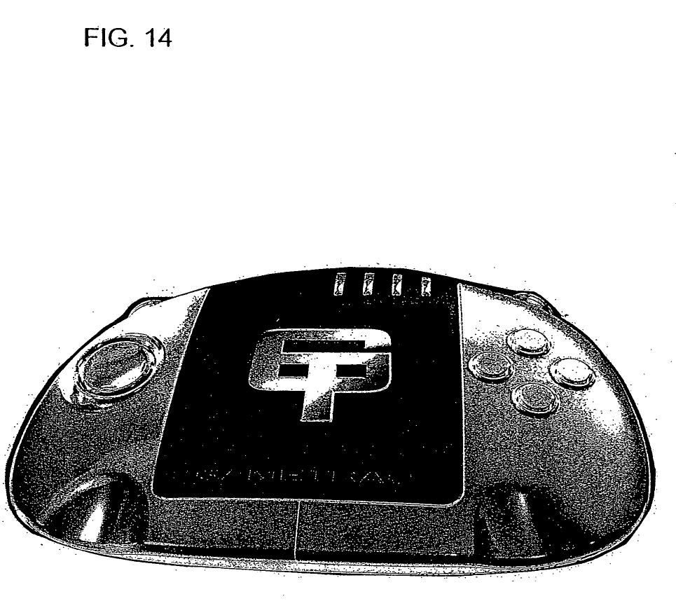

FIG. 2 illustrates the external appearance of the device 4, the device being portable with a size of 110 mm×60 mm×32 mm and a weight in the region of 120 g, being provided with a belt clip 20 for ease of portability while the entertainment functions of the device being used only to provide audio entertainment or when the entertainment functions not in use. The device 4 is provided with a display screen 21 and a control pad 22 configured for providing the normal controls available in game consoles and multimedia devices requiring minimal complexity and intuitive operation. Additionally however an alarm button 23 is provided for actuation in an emergency to generate an alarm signal. The external styling of the device 4 may be varied as illustrated for example in FIG. 14.

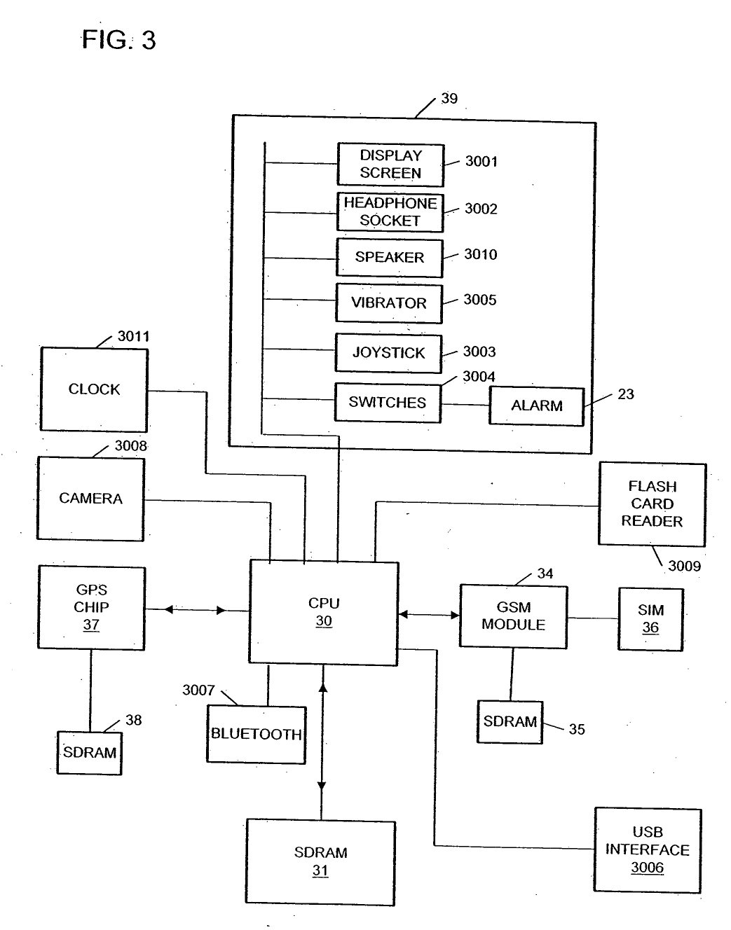

FIG. 3 illustrates schematically the hardware components of the device 4, illustrating primarily those hardware components associates with electronic processing. A central processing unit (CPU) 30 operates management software which runs under a Windows CE operating system and which controls and coordinates operation of a number of hardware and software modules. A synchronous dynamic random access memory (SDRAM) 31 stores programs and data used by the CPU 30.

The CPU 30 is of specialised construction for providing multimedia entertainment functions and in the embodiment is a Samsung S3C2440 multimedia chip for which SDRAM 31 stores software including games and multimedia applications.

A GSM (Global System for Mobile Communications) module 34 is coupled to the CPU 30 and is in turn provided with its own SDRAM 35 and SIM (Subscriber Identity Module) card 36. The GSM module 34 comprises a modem which provides communication hardware for communication with mobile network 5 using SMS (Short Message Service), MMS (Multimedia Messaging Service) and GPRS (General Packet Radio Service) protocols.

The GSM module 34 provides tri-band operation to allow international roaming and communicates with the CPU 30 via a serial port interface for at-command based communication. The GSM module 34 takes its power directly from an onboard battery (not shown) so as to be independent of power control to the CPU 30 and other components. This feature therefore facilitates the ability to optimise power management of the CPU 30 by allowing the CPU to be closed down while the GSM module 34 remains active for receiving communications and in particular for receiving a communication whose function is to effect start up of the CPU 30.

The serial interface also allows the GSM module 34 to be disabled under software control by the CPU 30 when the device 4 is to be operated under an environment in which mobile communications are prohibited, as for example when onboard an aircraft. This facility, referred to herein as Flight Mode, can be invoked by user actuation of a user interface 39 of the device.

A GPS chip 37 is coupled to the CPU 30 for providing the CPU with GPS data obtained by processing signals from satellites 11 and is provided with its own SDRAM 38. The GPS chip 37 is a high sensitivity chip available from SIRF and which has sufficient sensitivity to function within buildings and wooded areas. Data output from the GPS chip 37 includes current position, speed and heading data which is communicated to the CPU 30 via a high speed universal asynchronous receiver-transmitter (UART). The GPS chip 37 reports data to the CPU 30 on request at configurable intervals, the data being cached for use as required.

The GPS chip 37 may be disabled under software control via the CPU 30 for Flight Mode as referred to above.

The user interface 39 is coupled to the CPU 30 and comprises a display screen 3001, a headphone socket 3002, a speaker 3010, a joystick 3003, switches 3004 and a vibrator 3005. Inputs for selection and control of operation may thereby be input using the joystick 3003 and switches 3004 and the multimedia output delivered to the outputs provided by display screen 3001, headphone socket 3002 or speaker 3010 and vibrator 3005. The user interface 39 also includes the alarm button 23 which when actuated causes the CPU 30 to generate an alarm message for transmission via the GSM module 34 to the control unit 6.

In the present example, the display screen 3001 is a TFT LCD (Thin Film Transistor—Liquid Crystal Display) with a back light for providing high resolution colour images.

A Universal Serial Bus (USB) interface 3006 in the form of a mini-USB connector is coupled to the CPU 30 to allow loading of software by direct connection to a local Personal Computer (PC) 12 as illustrated in FIG. 1.

The CPU 30 is coupled to a Bluetooth module 3007 to provide close range wireless network connection with similar devices, as for example required when playing multi-user games in proximity with other users, or as an alternative means of interfacing with PC 12 for file transfer. The Bluetooth module 3007 can be disabled by software control by CPU 30 as for example during Flight Mode Operation.

A digital camera 3008 is coupled to the CPU 30 for the capture of still or video images for storage and display or for external transmission via the GSM module 34.

A flash card reader 3009 is connected to the CPU 30 to allow reading data from or writing data to memory cards inserted into the reader.

A clock 3011 is coupled to the CPU 30 for providing timing signals, particularly for use when time data is not currently available from the GPS chip 37.

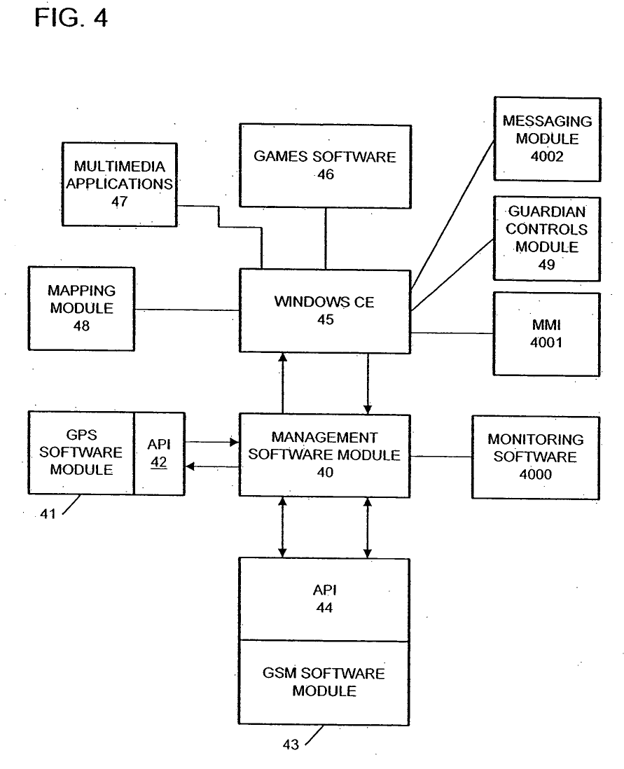

FIG. 4 illustrates schematically the software operated within the device 4 by the processing hardware of FIG. 3.

A management software module 40 provides software operated by the CPU 30 for managing the GPS data and alarm signals and for handling communications sent and received via the GSM module 34. A GPS software module 41 containing software operated by the GPS chip 37 communicates with the management software module 40 via an application programming interface (API) 42.

Similarly, the GSM software module 43 communicates with the management software module 40 via an API 44.

Processes for delivering entertainment and those requiring interaction with the user are operated under a Windows CE operating system 45 in the CPU 30.

The entertainment functions available in the device 4 are provided primarily by games software 46 and multimedia applications 47. In one embodiment, the games software 46 is provided by a Fathammer gaming engine supporting 2D and 3D gaming and multiplayer functions. Typically, games can be preinstalled at manufacture in SDRAM 33 or may be subsequently loaded, as for example using the flash card reader 3009 or via USB interface 3006. In another embodiment, the device 4 provides an open system in which games are executed through the installation of a removable Secure Digital (SD) memory card via the flash card reader 3009. During game operation, the display screen 3001, headphone socket 3002 or speaker 3010, and vibrator 3005 are used to present the game content to the device user 3 and the game responds to inputs from the joystick 3003 and switches 3004 as well as to inputs from other players received by the Bluetooth module 3007.

Multimedia applications 47 provide playback of MP3 audio and MPEG 4/WMV video stored in SDRAM 33. Media may be downloaded from a variety of sources including messages received via the GSM module 34 in MMS protocol, files downloaded from the internet using GPRS protocol from the GSM module, and files retrieved from flash storage via the flashcard reader 3009, Bluetooth module 3007 or USB interface 3006.

The multimedia applications 47 therefore provide for both storage, deletion, playback and other functions relating to a variety of media including images input from the camera 3008.

A mapping module 48 provides images for display on the display screen 3001 of a map of the geographical area around the current location of the device 4 for viewing by the device user 3, along with an indication of the current position, together with speed and heading information if moving. The mapping module 48 provides software for controlling the device 4 to take current GPS position data from the GPS software module 41 and include this information in a message sent to the control unit 6 via GSM module 34 requesting downloading of map information. The server 7 at the control unit 6 retrieves map data corresponding to the position of the device and responds using GPRS with graphical data defining the map which is then processed by the mapping module 48 to include the current position and displayed in the display screen 3001 on demand. The mapping module 48 updates the current position of the device in the displayed map using current GPS data and provides image manipulating functions including zoom and pan.

In an alternative embodiment, the control unit 6 processes the map data to include an indication of current position and provides updated map data as required to indicate changes in the current position.

To achieve zoom from one level of map magnification to another, an input from the user interface 30 is captured and interpreted as to whether positive or negative zoom is required. The mapping module 48 generates an appropriate instruction message which is output via the GSM module 34 to be transmitted to the control unit 6. In response, map data for the requested level of zoom is returned in a response message and the mapping module 48 generates data for operating the display to display the new map. Similarly, when pan operations are required, an input event is captured and a message generated to request a new map in which the required pan is implemented, typically by generating the x,y coordinates to become the centre of the new map or by requesting an incremental displacement of the centre coordinates in the north/south or east/west direction according to requirements of the device user 3. A response message containing new map data for the panned map is then processed by the mapping module 48.

The mapping module 48 is also configured to provide display of access control information set by the guardian user and defining where the device user 3 may or may not travel with the device 4. The display of this information is useful for the device user 3 in determining the boundaries of permitted access and the display may also be used during setting of new access control information by the guardian user 2 when operating the device 4. Setting of access control information requires use of a secure access procedure such as input of a PIN code.

A guardian controls module 49 handles the setting and configuring of the device 4 to set various guardian controls such as the access control information which is monitored by monitoring software 4000. The monitoring software 4000 is responsible for monitoring functions such as generating alarm signals triggered by the current position or speed as indicated by the GPS data and for generating monitoring data to be transmitted for use in monitoring, including tracking data for tracking the current location, speed and heading of the device 4.

The monitoring software 4000 therefore applies a number of predetermined alarm criteria which may be set by the guardian control module 49.

MMI (Man Machine Interface) software 4001 is provided for interpreting user commands associated with use of the user interface, such as the switches 3004 and joystick 3003.

A messaging module 4002 provides message handling functions for messages received via the GSM software module 43 and directs message content to the relevant application or software module. Incoming SMS messages recognised as being for delivery to the device user 3 are stored and an audio visual alert generated. The message can then be displayed on demand via the display screen 3001. Messages and audio visual content delivered via other protocols may similarly be presented via the user interface 39 and this may require currently active multimedia applications or games software to be interrupted. The messaging module 4002 may be configured via the guardian controls module 49 to allow advertising messages, video clips or promotional material to be displayed in response to messages received from approved suppliers.

Various applications which may run in the device 4 may call upon the messaging module 4002 to provide communication with the control unit 6 to obtain data required by the application. For example, a routing application may respond to user input to find a route between the current location of the device 4 and some other location defined by user input. A message directed to the control unit 6 may then receive a response containing the routing information. In one format, the routing information may be transmitted as a simple SMS message in which directions are given in the form of text to be displayed in the display screen 3001. In another format, a map may be provided in the form of map data and including a graphical display of the preferred route, the map data being processed by the mapping module 48 for display. Optionally, the displayed map may be updated periodically, for example every 30 seconds, to show the current location of the device 4, as determined according to the GPS data, each update of the map requiring a message to be transmitted to the control centre 6 giving the current position and requesting an updated map, and a response message containing new map data being returned to the device for processing by the mapping module 48.

The basic hardware and software components of the device 4 have now been described. Since the functionality of the device 4 can readily be reconfigured by software changes or data configuration, the following examples provide a non-exhaustive set of functions which may be selected or combined for multiple use in the device. The particular monitoring functions provided by the device 4 will in general be set by the guardian controls module 49 in response to guardian user input, by configuring data at the manufacturing stage, or by the input of configuring data at the point of sale.

Monitoring Options

1. Monitoring data is provided by the device 4 on demand from the control unit 6 whenever the guardian user 2 requests a monitoring session using client computer 10 which uses browser software to display map information provided from the control unit 6.

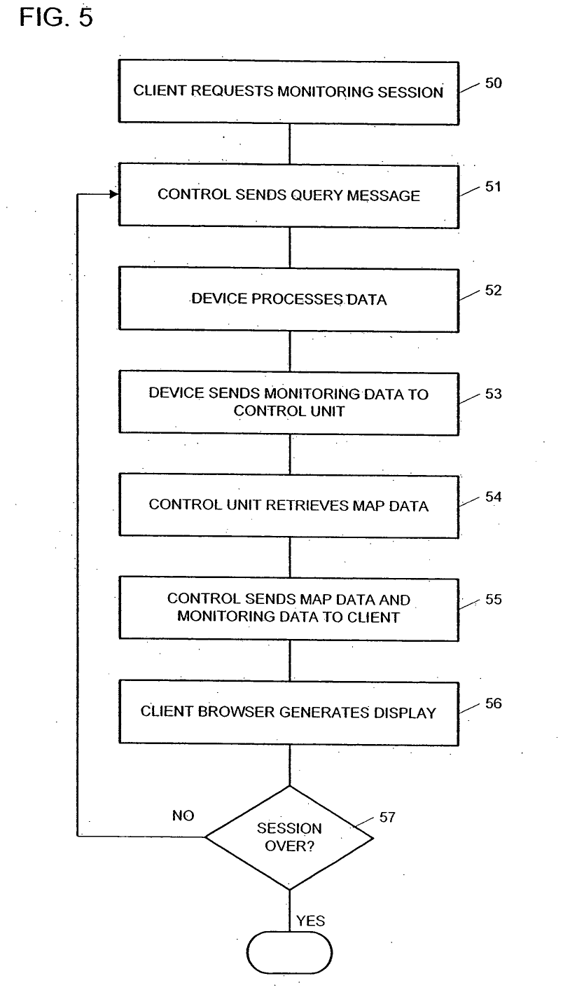

As illustrated schematically in the flowchart of FIG. 5, the guardian user 2 uses the browser software in the client computer 10 to access a web page of the control unit 6 and, after completing a log-in procedure, requests monitoring. The log-in procedure may involve security measures such as entry of a password or may employ secure encrypted handshake verification.

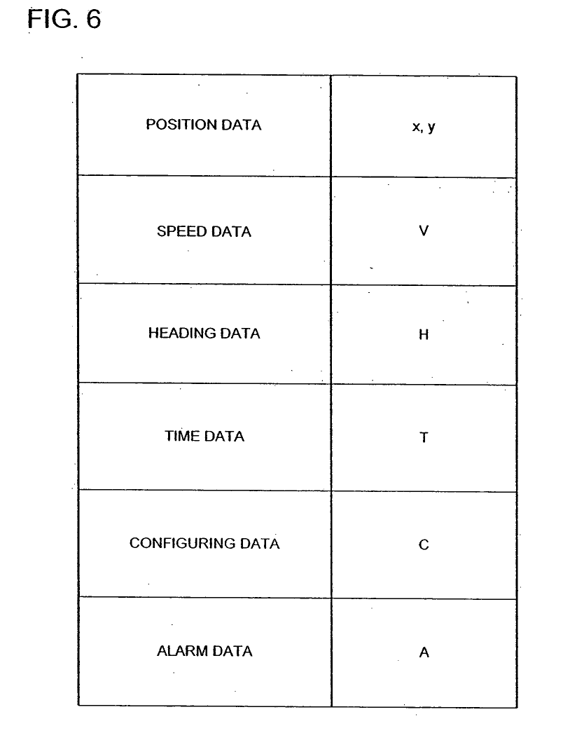

In response to this request, the server 7 of the control unit 6 sends a query message at step 51 using SMS protocol via mobile network 5 to the device 4. The SMS message is received by the GSM module 34 of the device 4. The monitoring software 4000 responds by preparing a response message as shown in FIG. 6. The response message contains data fields including at least position data indicating the current coordinates x, y of the device 4 or cached data giving the last known position. Additional fields may include time data, T, indicating the time at which the currently indicated position was obtained from the GPS module, speed data V and heading data H indicating the current speed and heading information provided by the GPS module, alarm data A representing the status of alarm flags generated in the device, and configuring data C representing the guardian control settings and other settings currently applied in the device.

The response message is formatted and forwarded in SMS format to the control unit 6 where the server 7 accesses the database 8 to obtain map information, corresponding to the position data x, y. A web page in HTML or XML format is prepared and transmitted over the Internet 9 to the client computer 10 for display to the guardian user 2.

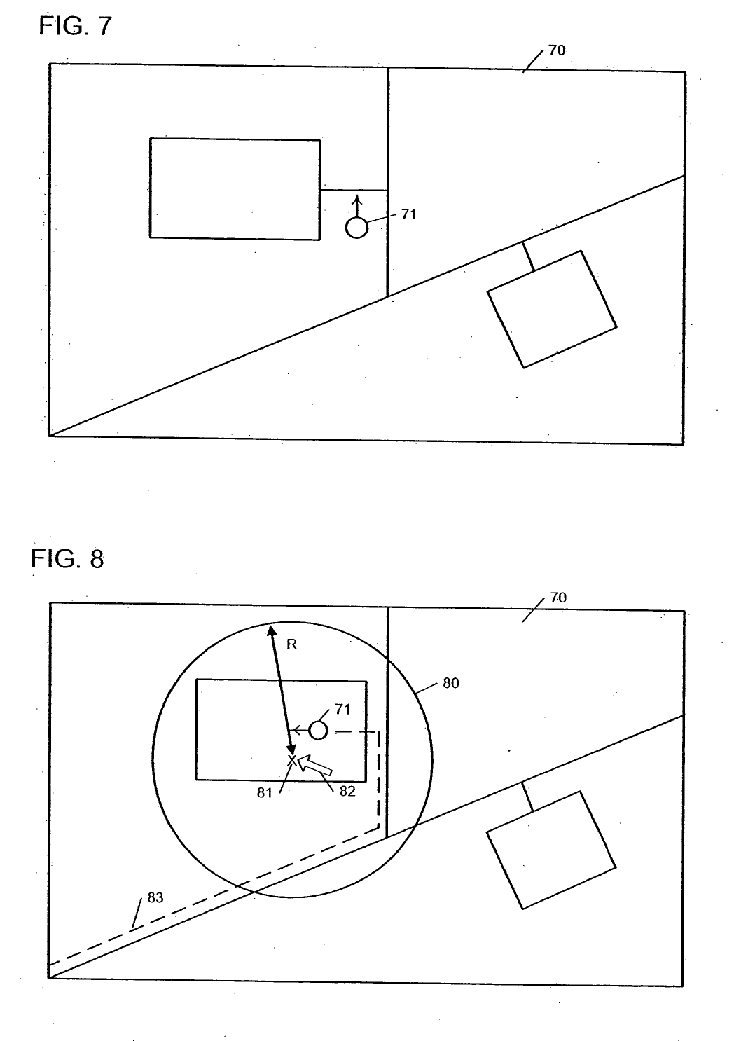

FIG. 7 illustrates such a web page in which a map 70 is graphically displayed with a device user position icon 71 displayed at a location representing the position data x, y.

Additional indicia such as alphanumeric data (not shown) may also be incorporated into the display map to include location details such as address, postcode, city and, where appropriate, further details from the database on the location including the names of schools, etc.

Referring to FIG. 5, for each time that the device 4 sends monitoring data to the control unit at step 53, the control unit generates updated map data at step 54 and at step 55 sends the updated map data and monitoring data to the client computer 10 for display at step 56.

When the guardian user 2 decides to end the session, the client computer 10 sends a logging-off message to the control unit 6 and at step 57 the procedure terminates with no further query messages being generated. Otherwise, the steps are repeated from step 51 onwards at a frequency determined by the control unit 6.

During the session, the client computer 10 may request details of the configuring data C so that the guardian user 2 can check control parameters and alarm settings. Alarm data A may also be displayed by the client computer 10, confirming that no alarm situation exists or has been generated by the device user 3 actuating the alarm button 23.

2. In a second option similar to the first option, additional features include the facility for the guardian user 2 to define geographical areas as a basis for triggering location alarms. FIG. 8 illustrates an example of a circular boundary 80 which has been defined to indicate a geographical area which surrounds a location, such as a school in which the device user 3 is permitted, the purpose of the boundary being to enable an alarm to be triggered when the position of the device user moves outside of the bounded area. The guardian user 2 enters boundary setting data comprising coordinates of a setting point 81 and a value of a radius R to define a circular boundary centred on the setting point 81. The browser software facilitates this setting operation by displaying a map of the location and enabling the coordinates to be entered simply by positioning a cursor 82 and clicking a mouse when the cursor 82 is at the required setting point 81. The radius R may then be defined by a drag and drop operation using a circular icon of variable radius.

The client computer 10 then is actuated to transmit setting data comprising the radius R and setting point data to the control unit 6 which responds by sending a configuring message containing the setting data to the device 4. On receiving the configuring message, the device 4 updates the stored configuring data C with the setting data. The configuring data may be updated periodically to turn on or off the location alarm according to times when the device user 3 is expected to be at the defined location. Alternatively, the configuring data may contain a schedule of times at which the location alarm is to be applied.

FIG. 8 illustrates a further feature of the browser software which provides a trace 83 illustrating the path of movement of the device user 3 as determined by successive sets of position data during the session.

During periods when the location alarm is set, the device 4 monitors the position data and compares the current position data with the stored configuring data defining the boundary 80. When the current position is determined to be outside the position 80, the device generates an alarm signal. The alarm data A contained in response messages to the control unit is therefore updated and results in communication to the client computer including the alarm which may be displayed using a predefined audio visual alarm call.

Additionally, the configuring data may define that when an alarm is triggered, the device 4 outputs an alarm message in SMS protocol via the mobile network 5 to a telecommunications terminal 14. The terminal address such as a telephone number of a mobile telephone constituting the terminal 14 is stored as part of the configuring data. The guardian user may therefore receive an SMS alarm message whenever the device user is detected to have left the location as defined by the boundary 80.

The configuring data may additionally contain further terminal addresses so that multiple terminals 14 are notified.

In this way, it is not necessary for a client computer 10 and the control unit 6 to be engaged in an active session for alarms to be detected by the guardian user 2.

The telecommunications terminal 14 may be a mobile telephone, a pager, another PC, a landline telephone or any other communications receiving device such as interactive television system. Communication with the terminal may alternatively be via the mobile network and internet 9. Additional network connections in this respect have been omitted from FIG. 1 for clarity.

3. A third option enables the guardian user 2 to set configuring data including the definition of the boundary 80 via direct access to the device 4. For this functionality, the device 4 includes in the guardian controls module 49 software enabling the mapping module 48 to obtain mapping data for the current location, the mapping data being displayed on the screen 3001 of the device 4 in a manner corresponding to FIG. 8 and the moveable cursor 82 being provided under control of the joystick 3003 to enable the setting point 81 and radius R to be set. This results in a circular boundary line being set as shown in FIG. 8. Guardian user access to this facility is regulated by security software requiring the use of security features such as entry of a PIN number.

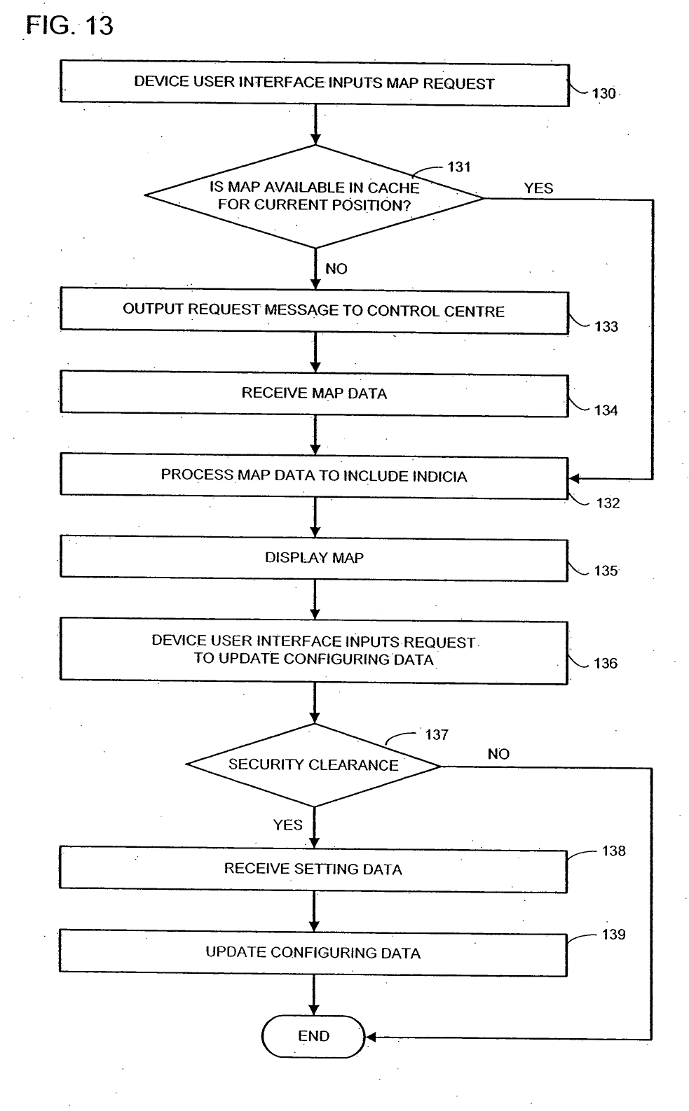

FIG. 13 illustrates schematically the steps involved in updating configuring data by direct access to the device 4. At step 130, the guardian user uses the user interface 39 to input a request for display of a map. At step 131, the mapping module 48 determines whether a map is currently available in cache memory for displaying a map at the current position of the device 4 and, if so, the map data is processed to include indicia representing the current position and any existing configuring data at step 132. If the map is not available in cache memory, a request message is output at step 133 to the control centre 6 and map data is subsequently received by return communication at step 134. The map data is processed as indicated above at step 132 and the processed map data is displayed at step 135.

Incidentally, steps 130 to 135 as described above may be used whenever the device user wishes to display the map in conjunction with his current position and any configuring data stored in the device 4.

When updating configuring data, the guardian user operates the user interface 39 at step 136 to input a request for updating. At step 137, the guardian controls module 49 determines whether the current user has the correct security clearance by requesting a PIN number or similar security feature. If clearance is granted, the setting data is entered at step 138 via the user interface and at step 139 the configuring data is updated and the process ends. If security clearance is not granted at step 137, the process ends without further setting data being receivable by the device 4.

The guardian user 2 may alternatively access this facility by means of a user interface of PC 12 connected via USB or wireless connection to the device 4.

In an alternative embodiment, the map data may be processed by the control unit 6 to incorporate indicia as demanded in the request message so that step 132 can be omitted.

4. A fourth option provides for the device 4 generating an alarm condition when the current speed as measured from the GPS data exceeds a threshold value set by the guardian user 2 as part of the configuring data C. The alarm condition may be signalled using any of the above mentioned options, including generation of one or more SMS messages or communicating the alarm status as part of alarm data A in a response message to the control unit 6 during a monitoring session.

5. A fifth option provides for actuation of the alarm button 23 to result in the device 4 generating a message in SMS format to terminal 14 whose address is defined in the configuring data C. Multiple addresses may define multiple terminals 14. This alarm message may correspond to the response message of FIG. 6 by including not only the alarm status but position data for the last known position of the device, speed and heading data, and the time of the last known position being recorded.

6. A sixth option provides for the device 4 being responsive to received messages from a terminal 14 by generating a response similar to the response message of FIG. 6, including position, speed, heading data and the alarm status A. In this way, if the guardian user 2 does not have immediate access to client computer 10, they may determine the safety of the device user 3 by making a telephone call or SMS message. The response message is preferably generated as a SMS message but the query message from the terminal may be either a conventional telephone call or SMS message, or other protocol signal. The device 4 checks the authenticity of the request message by comparing the dialling information identifying the call against stored details in the configuring data. Only if the caller is identified as being authenticated will the response message be generated.

The authenticity of the request message may alternatively be checked by the control unit in response to a request message from the device 4.

7. A seventh option replaces the client's computer 10 by a television set having interactive functions, as for example in the case of a television connected to a cable TV network or satellite based system. The above described functions performed by the client computer 10 and browser software may be performed by equivalent hardware and software associated with the television. In one option, the television service provider prepares the data for on screen display in HTML for transmission to the television set and is responsive to commands entered using a remote control handset actuated by the guardian user 2.

In the above described monitoring options, the exchange of messages between control unit and device, and other messages such as alarm messages, are described as using SMS protocols. Other protocols such as GPRS may alternatively be used.

Downloading of Map Data

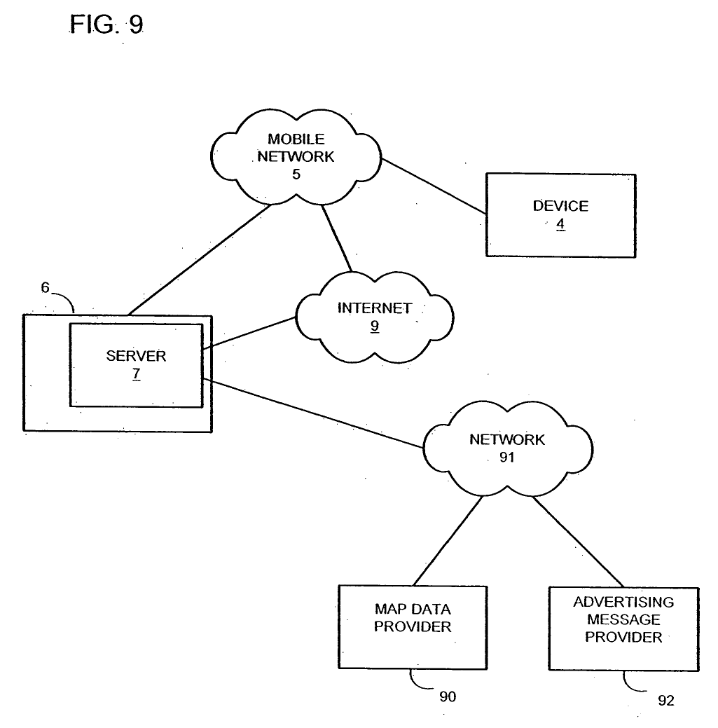

As described above, the mapping module 48 is responsible for originating a message sent to the control unit 6 requesting graphical data defining the map which is to be processed by the mapping module 48 in order to display a map showing the current position of the device user 3 and optionally additional information such as boundaries for access control. Such messages are also generated when zoom or pan function are initiated by user input. Since the graphical data defining the maps, i.e. the map data, is typically proprietary information made available under license, access to the map data may be via a communication link with a map data provider 90 as indicated schematically in FIG. 9. The map data provider 90 comprises a server computer with access to data files including map data covering the relevant geographical area. The server 7 of the control unit 6 provides a means of retrieval of the required map data on demand and responds to a request message from the device 4 by transmitting a request to the map data provider 90 via a communications link such as a network 91. The map data provider 90 replies with a message containing a data file of the relevant mapping data which the server 7 then receives and transmits to the device 4 via the internet using GPRS protocol. The device 4 receives the packetised data which is processed by the mapping module 48 to produce display data for displaying maps corresponding for example to those of FIGS. 7 and 8.

Map data may similarly be retrieved from a map data provider 90 when supplying map information to a client terminal as described above with reference to FIG. 1, the terminal for example being any one of a client computer, a telecommunications terminal such as a WAP enabled telephone, a personal digital assistant (handheld computer), a digital television or equivalent device having display and browser software.

Since the device 4 has operational capabilities worldwide, the use of one or more map providers avoids the problem of needing to store large amounts of mapping data on board the device 4.

Advertising Messaging

The device 4 is able to receive and display advertising messages. The term “advertising message” in this context is to be understood to be broadly construed as including public service messages, information about new products of the device manufacturer, previews of new games, videos and audio products, as well as general commercial advertisements equivalent to those provided for television broadcasts.

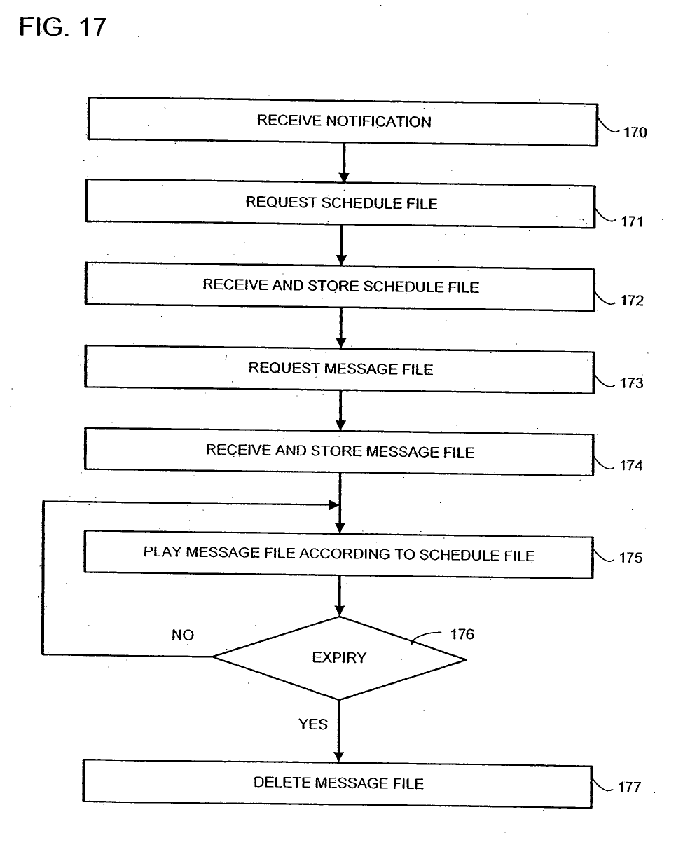

The preferred form of advertising message is by way of media files communicated to the device 4 from the server 7 via the mobile network 5 via HTTP (Hypertext Transfer Protocol) or FTP (File Transfer Protocol) as described below with reference to FIG. 17. As illustrated schematically in FIG. 9, an advertising message provider 92 is connected to the server 7 via network 91 and is operable to generate messages to be downloaded to the device 4.

Typically, at the time of purchasing the device 4, the purchaser is invited to accept an option to undertake to receive a schedule of advertising messages which may for example be limited to a specific number of messages per month.

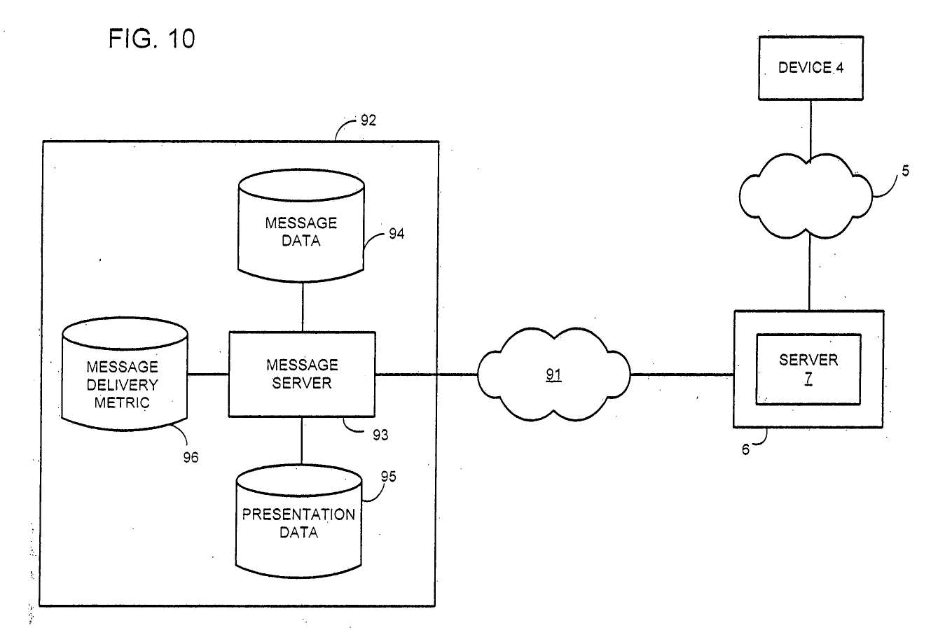

FIG. 10 illustrates schematically the manner in which the advertising message provider 92 is configured. A message server 93 is connected to network 91 for communicating with the server 7 of the control unit 6 and has access to a database of message data 94 for a number of advertisers to enable individual message files to be generated such that for example each message file contains a video clip specific to a given advertiser. The message server 93 also has access to a database of presentation data 95, the presentation data defining the manner in which the video clips are presented in terms of style, logos specific to the advertising message provider and the control unit 6.

The message server 93 also has access to a database of message delivery metrics 96 defining the selection and timing of advertising messages to be sent to each device 4 of a set of devices 4 served by the control unit 6.

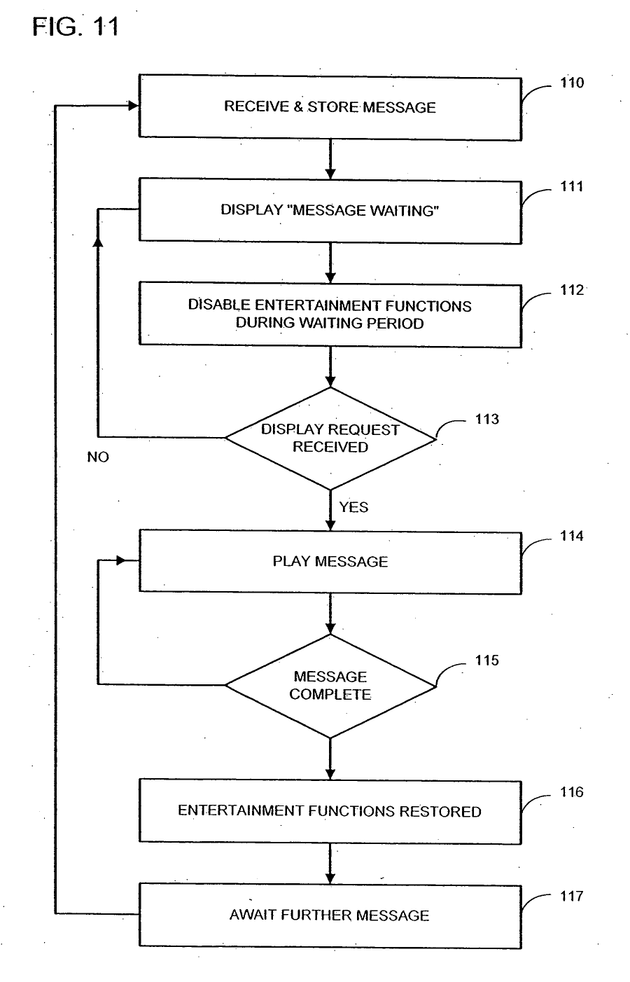

When a message delivery event is triggered by a schedule of message delivery, the schedule message is retrieved from the message data 94 and merged with the presentation data 95 to provide a message file. The message file is transmitted by a network 91 to the server 7 and onwards to the device 4. The device 4 responds by receiving and storing the message as represented by step 110 in FIG. 11.

The device 4 then provides an indication to the device user that a message is awaiting viewing. In this embodiment, the messaging module 4002 processes a received advertising message file and generates output data causing display screen 21 to display a notification message “message waiting” as indicated at step 111 and awaits receipt of a message play request input from the device user 3 via the control pad 22 as an instruction to display the message. During this waiting period, the entertainment functions of the device are temporarily disabled. These functions include the ability to play games, playback video and audio material, and provide any other entertainment features of the device. The disabling step 112 ends when it is determined at 113 that the message play request input has been received. The device 4 then proceeds to play the message at step 114, the messaging module 4002 processing the received advertising message file and causing the relevant multimedia application 47 to execute using the data file received in the message file.

The device user 3 is thereby presented with the advertising message in the form of a video clip, audio clip, or other formats such as animated graphics.

When it is determined at 115 that playback of the advertising message has been completed, the entertainment functions of the device 4 are fully restored at step 116 and further messages are awaited at 117. This temporary interruption of availability of entertainment function provides an incentive to ensure that the advertising message is delivered to the device user 3.

In an alternative embodiment, messages which are received and stored are cached for subsequent use at predetermined times, the transmitted message containing a data field setting a time and date at which the message is to be displayed.

The device 4 may alternatively receive and store one or more advertising messages with a separate schedule file which is processed by the messaging module to present the above messages at predetermined times according to the schedule.

An embodiment in which a schedule file is utilised to manage one or more advertising messages will now be described with reference to FIG. 17.

In this embodiment, the number of SMS messages to the device 4 is reduced to thereby reduce cost. In order to initiate a set of one or more advertising messages being delivered to a device 4, the server 7 generates a single SMS message to that device. At step 170 of FIG. 17, the device receives the SMS message which is a notification providing an address on the server 7 of a schedule file.

At step 171, the device 4 responds to the notification by initiating a GPRS session via the mobile network 5 to request the schedule file. In response, the server 7 sends the schedule file via GPRS to be received and stored at step 172 in the device 4.

The schedule file is an XML file containing details of a set of one or more advertising message files, including for each message file the address in the server 7 at which the message file can be accessed.

At step 173, the device 4 requests via GPRS the message file which is then transmitted by GPRS to the device 4 where it is received and stored at step 174.

The device 4 at step 175 is then able to play the message file in the manner defined in the schedule file. This may involve playing the message file at predefined intervals over a period of one or more days until such time as an expiry time for the message file is reached. When expiry is detected at step 176, the message file is deleted at step 177.

Table 1 gives a detailed example of the content of a schedule file. Successive data fields of the file as set out in table 1 are as follows.

The version of XML schedule file is indicated. The device 4 periodically requests updates to the XML file so that it is appropriate for the current issue of schedule file to be identified by a value representing the file version.

The minimum back to back time is defined in minutes, thereby specifying the minimum interval between successive playing of the message file. It is thereby possible to avoid excessive frequency in advertising message delivery.

An XML tag “smartadd” defines an address from which the message file can be downloaded.

A “file name” field provides the name of the file containing the advertising message.

A “start time” field indicates the earliest time at which the message file is to be played, in other words the starting date and time from which delivery of the advertising message is to commence.

Similarly, an expiry time is indicated, providing the last date and time at which the advertising message is to be delivered, and triggering the deletion of the message file at step 177 of FIG. 17.

A “play type” field defines the priority given to playing the message file in relation to other activities of the device. In this embodiment, a normal setting is to not allow the advertising message to interrupt activities of the device such as game playing, media delivery or other user functions of the device 4.

A “repeat count” field defines the number of times that the message can be repeated before being deleted.

A “repeat time” field defines the number of minutes between repeat message play.

An “order” field defines a hierarchical order between competing advertising message files, the message file having the highest order being played in preference to those having a lower order as defined in the field value contained in the XML file.

In this embodiment, the use of the schedule file provides efficient management of advertising message files and requires only a single SMS message via the mobile network to initiate a succession of advertising messages, the downloading and playing of the message files being controlled by the XML files, successive versions of which are received by the device. The schedule file itself defined the time at which a next schedule file is to be retrieved. In exceptional circumstances, a further SMS message may trigger the downloading of a new schedule file when it is required to restructure the playback of advertising messages with immediate effect.

A further embodiment provides an advertising message requiring user interaction via the user interface 39, as in the case of a competition or survey, and the message takes the form of an application session which ends when all required user responses have been received.

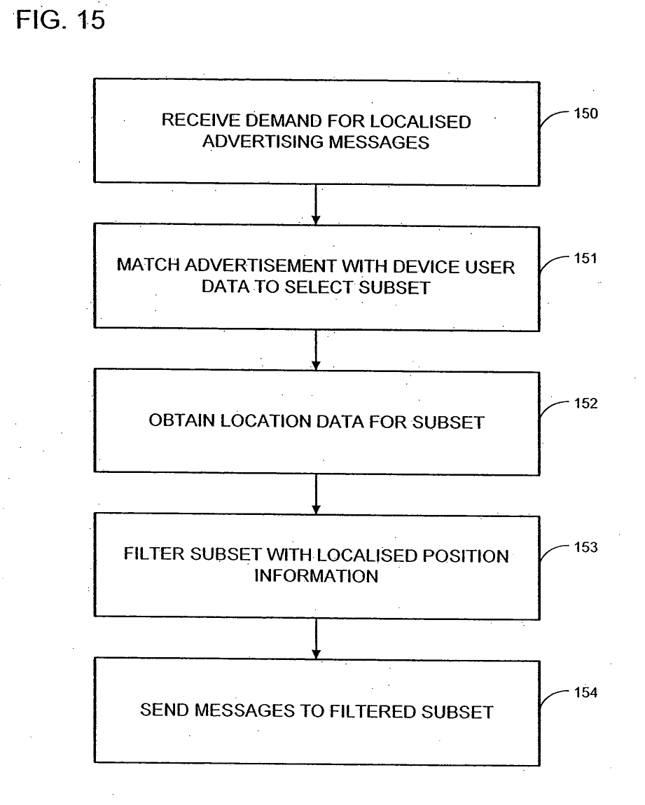

FIG. 15 illustrates schematically the manner in which advertising messages relating to a product or service available at a specific location may be targeted to devices 4 whose position is determined to be in the immediate locality or within a specified radius.

At step 150, the server 7 receives a demand for such localised advertising messages to be generated, for example from advertising message provider 92 of FIG. 9.

At step 151, the server 7 refers to a database which contains details of each of a set of devices currently operating in the system 1 and matches subscriber information for each device with details of the advertising message in order to select a subset of devices which are eligible to be targeted with the advertising message.

This matching process may contain a number of stages, commencing with an initial step of determining whether, for each device, the subscriber has opted to receive such advertising messages. Where the subscriber has agreed to receive a specified number of advertising messages within a given time period, for example 3 messages per day, the history of sending previous advertising messages needs to be checked to ensure that the number of messages sent does not exceed the allowed number. Similarly, the subscriber may have agreed to accept messages at certain times or certain days of the week and this information is compared with the current demand for the advertising message.

The resulting subset represents those devices for whom the subscriber has agreed to accept a message and for which the currently demanded advertising message can be delivered in accordance with an agreed schedule for each subscriber. Further filtering may rely upon matching features of the advertisement with preferences of the subscriber, such as interest in sport, music and games.

At step 152, location data for each device of the subset is then acquired, the location data for each device being required to be established with sufficient definition to allow a determination to be made as to whether the device 4 is in the required location to be targeted. In order to acquire the location data, the server 7 sends to each device 4 a message requesting an indication of the current position of the device. The device responds with position data from its GPS software module 41, thereby enabling the server to accumulate position data for each device in the subset. The position criteria for the received demand for localised advertising messages are then used to filter the subset so that for example where the localised advertising messages are required within a one mile radius of a retail outlet with a promotion for a specific product, those devices identified from their position data as being outside of the one mile radius will be excluded from the subset, thereby providing a filtered subset of devices in the required location.

At step 154, advertising messages are provided to each device of the filtered subset. In this embodiment, an SMS message is transmitted to each device of the filtered subset, the message containing the URL (Universal Resource Locator) at which a schedule file and then the advertising message can be downloaded via the internet using the procedures described above with reference to FIG. 17 and Table 1. The advertising message downloaded by the device may typically be a file of size 2 to 3 megabytes containing the advertising message in the form of a video clip. The device user may then be invited to download a map showing the location of the outlet. The advertising message may also include a redeemable token which can be exchanged at the retail outlet for a discount or promotional offer. The token may be in the form of a machine readable indicia such as a barcode 162 which can be displayed at the point of sale and scanned by a conventional barcode reader 161, so that to redeem the token the device user simply presents the device 4 at the point of sale with the token displayed in the display screen 21.

The server 7, map data provider 90 and advertising message provider 92 together comprise a control system for providing advertising messages. These entities may be located separately and linked by networks as shown in FIG. 9 or may be co-located as a single entity, and may comprises one or more processing units such as server computers.

In an alternative embodiment, the server 7 sends the advertising message directly to the device 4. Other messaging protocols may be used where appropriate.

In an alternative arrangement, step 152 includes an initial step of determining the approximate location of each device by obtaining cell identification information from the mobile network 5, such information being generally available when the device 4 is registered with the mobile network and receiving signals within one of the cells of the cellular network. The position information available is less specific than available via the GPS data of the device 4 itself but can be used to initially reduce the subset of devices under consideration, thereby reducing the number of messages which need to be sent in a second step in order to obtain the GPS position data from each device.

In a further arrangement, the cell information available from the mobile network may be relied upon to provide location information of sufficient detail for the purpose of distributing the advertising messages, without reliance upon the GPS position data, thereby further reducing the amount of message traffic required.

Information may be collected for subsequent analysis as to the number of advertisement messages sent, the identity of each device user receiving an advertising message, whether or not the advertisement was successful in inducing the device user to go to the specified location, and whether the barcode was used to take advantage of the special offer.

This collected information may then be formatted in appropriate metrics to be provided to the advertiser as feedback for use in subsequent advertising campaigns.

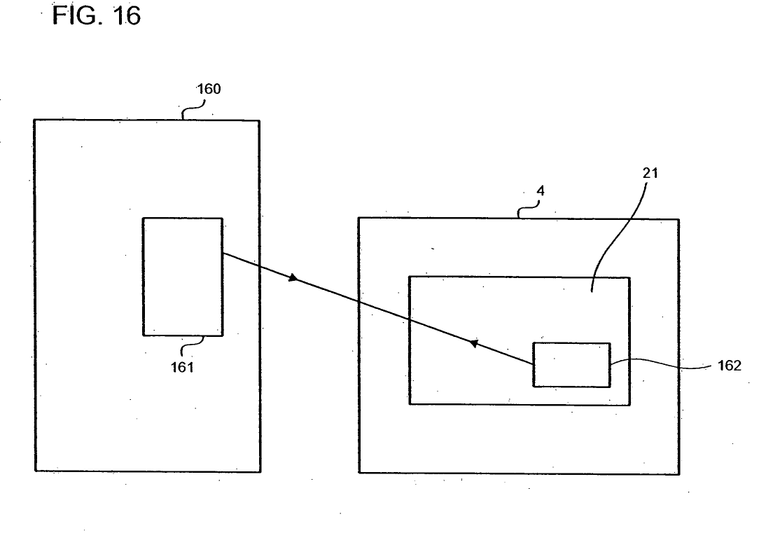

FIG. 16 illustrates schematically the device 4 being presented to a point of sale check-out 160 where a barcode reader 161 is used to read a barcode 162 displayed in the display screen 21 of the device. One of the requirements of the display screen 21 is therefore to have sufficient display resolution for the barcode 162 to be reliably detected.

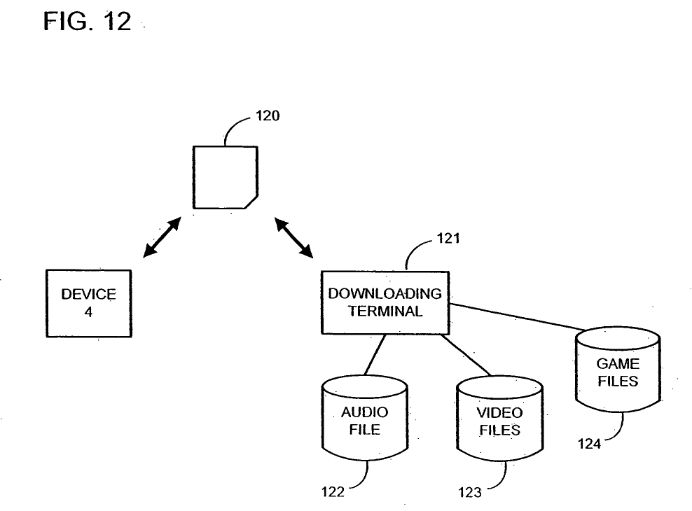

FIG. 12 illustrates schematically the manner in which the device 4 may obtain input of audio content, audio visual content and games stored on a secure digital (SD) card removably inserted into the card reader 3009. FIG. 12 illustrates a card 120 which is a secure digital card of high memory capacity.

Such cards can potentially hold hundreds of songs in MP3 format and can be used to receive audio files for example from a music kiosk or other downloading terminal 121 in which a user selects a desired set of songs. Similarly, feature length films can be downloaded in compressed audio visual format. Games may similarly be downloaded. The downloading of the above media may typically take place at the point of sale where the user purchases the rights to receive and use the downloaded media and simply presents the card 120 for insertion into a reader/writer at the point of sale. The user selection s then retrieved for transfer to the card 120 from databases 122, 123, 124 of audio files, video files and game files.

Alternatively, the card 120 may be presented to a reader/writer of a personal computer with access online to download media files on payment of a purchase fee via online transaction.

In this way, the media presented to the device user 3 can be refreshed in a convenient manner.

It may also be possible to purchase new cards 120 pre-programmed with media files, as and when such programmed cards become available commercially.

Alternative configurations are also envisaged in which for example the device 4 transmits GPS data to the control unit 6 for processing to determine whether an alarm should be triggered. In this arrangement, the location boundary and speed threshold data are held by the server 7 in the database 8 and the GPS data compared with thresholds in order to determine whether to trigger an alarm. The alarm signals in this example originate from the control unit 6 and may be then transmitted to the client computer 10 (or corresponding television set), or to one or more telecommunications terminals 14. The server 7 may also process map data before downloading to the device 4 so as to include indicia such as position, speed reading and boundaries.

Preferably the alarm status is not indicated by the device 4 to the device user 3 by any change in the display or audio outputs. Similarly, the device user 3 may be unaware of any configuration data set by the guardian user 2.

The device 4 may be configured to have boundaries 80 which, instead of defining permitted locations, define geographical areas in which the device user is not permitted to enter so that an alarm is generated when the position of the device user is determined to be within the boundary.

The use of the speed threshold is primarily intended to detect whether the device user 3 is travelling on a vehicle, this being a primary concern to the guardian user 2 when in the role of monitoring the safety of the device user since most abductions will involve transportation in a vehicle.

The speed threshold will therefore need to be selected according to the prevailing options available to the device user, for example depending on whether the device user has access to a bicycle, or a bus.

In the above description, reference is made to a device user and guardian user. In one application of the invention, the device user is a child and the guardian user is a parent.

There is a need to provide child monitoring for the benefit of parents, or equivalent responsible adults having a supervisory role for safety reasons, in order for example to guard against the possibility of abduction. It is important for a parent to know the location of a child for behaviour monitoring, for example to check whether the child is at a prescribed location such as a school or whether the child is visiting a location from which the child has been prohibited.

Accordingly, the above described embodiments are applicable to child monitoring by a parent or equivalent responsible adult having a supervisory role for safety reasons and references to “device user” and “guardian user” may be construed accordingly in this aspect of the invention.

In processing the GPS data under poor signal conditions, position and speed errors are likely to vary inversely with signal strength. In order to avoid spurious alarms due to poor signal conditions, the threshold can be set artificially high. Alternatively, a form of digital filtering may be applied to the position and speed data so that the data values are integrated with a longer time constant during low signal conditions. Alternatively, statistical averaging over a number of samples may be performed in such a way that the reliability of the sample is determined from the standard deviation of a set of most recent samples.

As mentioned above, the device 4 has an on-board battery. The battery is rechargeable and replaceable. To maximise standby and operating periods, power management techniques are utilised under control of the management software module 40, allowing the CPU 30 to be shut down during periods of inactivity. Sufficient hardware is however maintained active to allow the GSM software module 43 to continue to function and in particular to receive communications allowing the management software to react by waking up the processor and other functions, for example when a query message is received requiring a response as to the current status of the device 4.

The setting of configuring data and viewing of monitoring information has been described above with reference to the guardian user 2 operating a client computer 10. The client computer may be constituted alternatively by other forms of remote terminal having browser software, including for example personal digital assistants and WAP enabled telephones, or similar hybrid communications and computing apparatus which may function as a terminal for the described purpose.

In additional embodiments, in place of advertising messages, promotional messages, public service information messages, survey messages and competition messages may be presented and the above description should be alternatively interpreted with these terms substituted where appropriate.

Although described primarily with reference to the GSM cellular wireless system, other forms of cellular wireless telecommunications or other forms of wireless communication may be equally well used in alternative embodiments. Similarly, positioning systems other than GPS may be employed where appropriate and available, or a combination of positioning systems utilised where appropriate under local conditions.

It will be apparent that many of the features of the above disclosed device may be embodied in computer programs controlling operation of a microprocessor based portable device. An aspect of the invention therefore comprises a computer program, or series of software modules for controlling a processor of a device to perform the functions described above. Since the computer program may be stored in a storage medium, a further aspect of the invention is constituted by a storage medium storing a computer program or series of software modules as indicated above.

Such computer programs may be downloaded over a network such as the internet and therefore a further aspect of the invention is embodied in an electronic signal carrying the computer program.

Appendix A

TABLE 1

| XML Theme | | |
|---|---|---|
| Attributes | Values | Description and Usage |
| version | 1 | Describes the version of XML Schedule being |
| | | downloaded |
| minBackToBack | default | Specifies the minimum time in minutes between |
| | 30 | advertising message being able to play. |

| XML Tags | Description and Usage |
|---|---|
| SMARTADD | Describes the XML node for an |
| | advertising message |

| Advertising | | |
|---|---|---|
| Message XML | | |
| Attributes | Values | Description and Usage |
| filename | ftp/http/https link | Partial link of file to download, i.e. |
| | | dnloadshed.asp |
| | | With the OTA prefix of: |
| | | http://www.SmartAdds.com |
| | | The file to download will be |
| | | http://www.SmartAddds.com/dnloadshed.asp + id |
| playStartTime | day/month/year@hr:min | Earliest time that the advertising message should |
| | | be played. |
| | | I.e. |
| | | 16/04/2004@07:30 |
| playExpireTime | day/month/year@hr:min | Latest time that the advertising message should be |
| | | played. |
| | | e.g. |
| | | 16/04/2004@16:30 |
| playType | normal | Message is played at the earliest opportunity after |
| | | playStartTime (optional, default = normal) |
| repeatCount | 0 . . . n | Number of times advertising message is repeated |
| | | before deletion (optional) |
| repeatTime | 0 . . . n (minutes) | Number of minutes (minimum) between repeat |
| | | loops (optional, default 30 minutes) |
| order | 0 . . . n | Order of message playback, higher order |
| | | messages will be played in preference to lower |
| | | order messages (optional, default 0) |

1. A portable electronic device comprising:
a user interface comprising a display;
an entertainment system operable to output entertainment media signals to the user interface;
a tracking system operable to generate tracking data comprising at least position data representative of a position of the device;
a monitoring system operable to process the tracking data to obtain monitoring data comprising at least the position data;
a wireless communications system operable to transmit the monitoring data for reception by a control centre and to receive map data representative of an area corresponding to the position of the device as indicated by the position data; and
a mapping module operable to process the map data to generate display data for selectively presenting on the display a map with indicia representative of at least the position data.

2. A device as claimed in claim 1 wherein the tracking system is operable to generate the tracking data so as to comprise heading data representative of the direction of movement of the device and wherein the mapping module is operable to generate the display data so as to include indicia representing the heading data.

3. A device as claimed in claim 1 wherein the tracking system is operable to generate the tracking data so as to include speed data representative of the speed of movement of the device and wherein the mapping module is operable to generate the display data so as to include indicia representing the speed data.

4. A device as claimed in claim 1 wherein the monitoring system is operable to compare the tracking data with stored configuring data to determine whether an alarm condition exists and wherein the monitoring system is operable to generate the monitoring data to comprise alarm data representative of the status of at least one alarm condition.

5. A device as claimed in claim 4 wherein the configuring data defines a geographical area and
wherein the monitoring system is operable to compare the position data with the configuring data to generate a location alarm according to whether or not the position of the device is determined to be within the geographical area.

6. A device as claimed in claim 5 comprising a guardian controls module operable to enter the configuring data into storage via the user interface and wherein the mapping module is operable to generate the display data so as to display a map as a reference for entering parameters defining the geographical area during entry of the configuring data.

7. A device as claimed in claim 6 wherein the guardian controls module comprises security means for allowing access to enter or change the configuring data only to authorised users.

8. A device as claimed in claim 6 wherein the guardian controls module is operable to control the user interface to display a movable boundary line on the displayed map, the guardian controls module being responsive to actuation of user controls of the user interface for moving and setting the boundary line at a desired position to define the geographical area.

9. A device as claimed in claim 1 comprising routing means responsive to user input via the user interface to generate a request message for requesting route data defining a route between the current position of the device and a specified location;
the wireless communications system being operable to transmit the request message to the control centre and to receive a response message containing the route data for display by the user interface.

10. A device as claimed in claim 9 wherein the mapping module is operable to generate display data for displaying the route data as a map indicating the route.

11. A device as claimed in claim 1 wherein the mapping module is responsive to user request via the user interface to generate a request message for updated map data according to at least one of a zoom command and a pan command defined by the user request;
the wireless communications system being operable to transmit the request message to the control centre and to receive a response message containing the updated map data.

12. A method of operating a portable electronic device, the device comprising a user interface comprising a display and an entertainment system operable to output entertainment media signals to the user interface; the method comprising the steps of,
operating a tracking system to generate tracking data comprising at least position data representative of a position of the device;
operating a monitoring system to process the tracking data to obtain monitoring data comprising at least the position data;
transmitting the monitoring data by operation of a wireless communications system for reception by a control centre and receiving map data representative of an area corresponding to the position of the device as indicated by the position data; and
operating a mapping module to process the map data to generate display data for selectively presenting on the display a map with indicia representative of at least the position data.

13. A method as claimed in claim 12 wherein the tracking system generates the tracking data so as to comprise heading data representative of the direction of movement of the device and wherein the display data includes indicia representing the heading data.

14. A method as claimed in claim 12 wherein the tracking system generates the tracking data so as to include speed data representative of the speed of movement of the device and wherein the display data includes indicia representing the speed data.

15. A method as claimed in claim 12 wherein the monitoring system compares the tracking data with stored configuring data to determine whether an alarm condition exists and wherein the monitoring system generates the monitoring data to comprise alarm data representative of the status of at least one alarm condition.

16. A method as claimed in claim 15, wherein the configuring data defines a geographical area and wherein the monitoring system compares the position data with the configuring data to generate a location alarm according to whether or not the position of the device is determined to be within the geographical area.

17. A method as claimed in claim 16, the device comprising a guardian controls module which enters the configuring data into storage via the user interface and wherein the mapping module generates the display data so as to display a map as a reference for entering parameters defining the geographical area during entry of the configuring data.

18. A method as claimed in claim 17, wherein the guardian controls module operates security software allowing access to enter or change the configuring data only to authorised users.

19. A method as claimed in claim 17, wherein the guardian controls module controls the user interface to display a movable boundary line on the displayed map, the guardian controls module being responsive to actuation of user controls of the user interface for moving and setting the boundary line at a desired position to define the geographical area.

20. A method as claimed in claim 12 comprising the step of generating in response to user input via the user interface a request message for requesting route data defining a route between the current position of the device and a specified location;
the wireless communications system transmitting the request message and receiving a response message containing the route data for display by the user interface.

21. A method as claimed in claim 20 wherein the mapping module generates display data for displaying the route data as a map indicating the route.

22. A method as claimed in claim 12 wherein the mapping module generates in response to user request via the user interface a request message for updated map data according to at least one of a zoom command and a pan command defined by the user request;
the wireless communications system transmitting the request message and receiving a response message containing the updated map data.

23. A control centre comprising:
receiving means for receiving monitoring data from a portable electronic device, the monitoring data comprising at least position data representative of the position of the device;
retrieval means for retrieving map data representative of an area corresponding to the position of the device as indicated by the position data;
and transmitting means for transmitting the map data to the device.

24. A control centre as claimed in claim 23, wherein the retrieval means comprises means for transmitting a request via a network to a map provider and a means for receiving via the network the map data from the map provider.

25. A control centre as claimed in claim 23 comprising means responsive to a request message from a client terminal to transmit the map data to the client terminal via a network.

26. A control centre as claimed in claim 25 comprising means for modifying the map data transmitted to the client terminal to include indicia representative of at least the position data.

27. A control centre as claimed in claim 25 comprising means for extracting from the monitoring data alarm data representative of the status of at least one alarm condition in the device and means for transmitting the alarm data to the client terminal.

28. A control centre as claimed in claim 25 comprising means for extracting from the monitoring data configuring data defining criteria for determining whether an alarm condition exists in the device and means for transmitting the configuring data to the client terminal.

29. A control centre as claimed in claim 28, wherein the configuring data comprises a geographical area against which the position data is to be compared in the device to determine an alarm condition and wherein the control centre is operable to transmit to the client terminal geographical information defining a map showing the position of the device and the geographical area.

30. A control centre as claimed in claim 25 comprising means for receiving setting information from the client terminal and means for transmitting the setting information to the device for updating the configuring data stored therein.

31. A control centre as claimed in claim 23 comprising means for receiving a request message from the portable electronic device, the request message requesting route data defining a route between the current position of the device and a specified location;
further comprising means for calculating the route data and means for transmitting a response message to the device containing the route data.

32. A control centre as claimed in claim 31 wherein the route data is representative of a map showing the route.

33. A control centre as claimed in claim 23 wherein the request message comprises at least one of a zoom command and a pan command, the control centre comprising means for obtaining updated map data in accordance with the required command, and
means for transmitting a response message containing the updated map data.

34. A method of operating a control centre comprising:
receiving monitoring data from a portable electronic device, the monitoring data comprising at least position data representative of the position of the device;
retrieving map data representative of an area corresponding to the position of the device as indicated by the position data;
and transmitting the map data to the device.

35. A method as claimed in claim 34, wherein the retrieval step comprises transmitting a request via a network to a map provider and receiving via the network the map data from the map provider.

36. A method as claimed in claim 34 comprising responding to a request message from a client terminal to transmit the map data to the client terminal via a network.

37. A method as claimed in claim 36 comprising modifying the map data transmitted to the client terminal to include indicia representative of at least the position data.

38. A method as claimed in claim 36 comprising extracting from the monitoring data alarm data representative of the status of at least one alarm condition in the device and transmitting the alarm data to the client terminal.

39. A method as claimed in claim 36 comprising extracting from the monitoring data configuring data defining criteria for determining whether an alarm condition exists in the device and transmitting the configuring data to the client terminal.

40. A method as claimed in claim 39 wherein the configuring data comprises a geographical area against which the position data is to be compared in the device to determine an alarm condition and wherein the control centre transmits to the client terminal geographical information defining a map showing the position of the device and the geographical area.

41. A method as claimed in claim 27 comprising receiving setting information from the client terminal, and transmitting the setting information to the device for updating the configuring data stored therein.

42. A method as claimed in claim 34 further comprising the steps of:
receiving a request message for requesting route data defining a route between the current position of the device and a specified location,
generating the route data, and
transmitting a response message containing route data.

43. A method as claimed in claim 42 wherein the step of generating the route data comprises generating map data representative of a map indicating the route.

44. A method as claimed in claim 34 comprising:
receiving from the device a request message for updated map data according to at least one of a zoom command and a pan command,
obtaining updated map data, and
transmitting the updated map data in a response message to the device.

45. A computer program comprising instructions for controlling a portable electronic device to perform the steps of a method, the device comprising a user interface comprising a display and an entertainment system operable to output entertainment media signals to the user interface; the method comprising the steps of;
operating a tracking system to generate tracking data comprising at least position data representative of a position of the device;
operating a monitoring system to process the tracking data to obtain monitoring data comprising at least the position data;
transmitting the monitoring data by operation of a wireless communications system for reception by a control centre and receiving map data representative of an area corresponding to the position of the device as indicated by the position data; and
operating a mapping module to process the map data to generate display data for selectively presenting on the display a map with indicia representative of at least the position data.

46. A storage medium storing a computer program comprising instructions for controlling a portable electronic device to perform the steps of a method, the device comprising a user interface comprising a display and an entertainment system operable to output entertainment media signals to the user interface; the method comprising the steps of;
operating a tracking system to generate tracking data comprising at least position data representative of a position of the device;
operating a monitoring system to process the tracking data to obtain monitoring data comprising at least the position data;
transmitting the monitoring data by operation of a wireless communications system for reception by a control centre and receiving map data representative of an area corresponding to the position of the device as indicated by the position data; and
operating a mapping module to process the map data to generate display data for selectively presenting on the display a map with indicia representative of at least the position data.

47. A portable electronic device comprising:
a user interface;
an entertainment system operable to output entertainment media signals to the user interface;
a tracking system operable to generate tracking data comprising at least position data representative of a position of the device;
a monitoring system operable to process the tracking data to obtain monitoring data comprising at least the position data;
a wireless communications system operable to transmit the monitoring data for reception by a control centre and to receive an advertising message containing data representative of an advertisement relevant to a geographical area containing the position of the device as indicated by the position data; and
a message control module operable to process the advertising message to generate output data for selectively presenting the advertisement via the user interface.

48. A device as claimed in claim 47, wherein the message control module is operable to generate output data for presenting via the user interface a notification message indicating that there is an advertising message waiting to be presented.

49. A device as claimed in claim 47 wherein the message control module is responsive to user input received via the user interface to initiate presentation of the advertising message.

50. A device as claimed in claim 49 wherein the message control module is operable to inhibit operation of the entertainment system after the notification message has been presented until the advertising message has been presented.

51. A device as claimed in claim 47 wherein the user interface comprises a display and the advertising message comprises one of a video clip and an animated graphics sequence.

52. A device as claimed in claim 47 wherein the communications system is operable to receive the advertising message in any one of HTTP and FTP protocol.

53. A device as claimed in claim 47 wherein the message control module is operable to extract from a communication received via the wireless communications system an address from which a schedule file can be retrieved, and further operable to initiate a communications session via the wireless communications system to retrieve said schedule file.

54. A device as claimed in claim 53 wherein the message control module is responsive to stored schedule data from the schedule file defining values of parameters for managing the display of one or more advertising messages.

55. A device as claimed in claim 54 wherein the message control module is responsive to values of the parameters comprising at least one of:
an earliest time at which an advertising message is to be displayed;
a latest time at which the advertising message is to be displayed;
a maximum number of occurrences of the advertising messages being displayed;
a minimum time interval between occurrences of the display of the advertising message; and
a level of priority with respect to other advertising messages for arbitrating the order in which a plurality of advertising messages are to be displayed.

56. A device as claimed in claim 54 wherein the message control module is operable to extract from the schedule data an address from which a message file containing the advertising message can be retrieved, and further operable to initiate a communications session with the address via the wireless communications system to retrieve the message file.

57. A device as claimed in claim 54 wherein the message control module is operable to extract from the schedule data a further address from which an updated schedule file containing updated schedule data can be retrieved and further operable to initiate a communications session with the further address via the wireless communications system to retrieve the updated schedule file and replace the schedule data with the updated schedule data.

58. A device as claimed in claim 53 wherein the communication containing the schedule file address is received via SMS.

59. A device as claimed in claim 53 wherein the communications session for downloading files is via GPRS.

60. A method of operating portable electronic device, the device comprising:
a user interface; and
an entertainment system operable to output entertainment media signals to the user interface;
the method comprising:
operating a tracking system to generate tracking data comprising at least position data representative of a position of the device;
operating a monitoring system to process the tracking data to obtain monitoring data comprising at least the position data;
operating a wireless communications system to transmit the monitoring data for reception by a control centre and to receive advertising message data representative of an advertisement relevant to a geographical area containing the position of the device as indicated by the position data; and
operating a message control module to process the advertising message data to generate output data for selectively presenting the advertisement via the user interface.

61. A method as claimed in claim 60 wherein the message control module generates output data for presenting via the user interface a notification message indicating that there is an advertising message waiting to be presented.

62. A method as claimed in claims 60, wherein the message control module is responsive to user input received via the user interface to initiate presentation of the advertising message.

63. A method as claimed in claim 62 wherein the message control module inhibits operation of the entertainment system after the notification message has been presented until the advertising message has been presented.

64. A method as claimed in claim 60, wherein the user interface comprises a display and the advertising message comprises one of a video clip and an animated graphics sequence.

65. A method as claimed in claim 50 wherein the communications system receives the advertising message in any one of HTTP and FTP protocol.

66. A method as claimed in claim 60 wherein the message control module is operable to extracts from a communication received via the wireless communications system an address from which a schedule file can be retrieved, and initiates a communications session via the wireless communications system to retrieve said schedule file.

67. A method as claimed in claim 66 wherein the message control module is responsive to stored schedule data from the schedule file defining values of parameters for managing the display of one or more advertising messages.

68. A method as claimed in claim 67 wherein the message control module is responsive to values of the parameters comprising at least one of:
an earliest time at which an advertising message is to be displayed;
a latest time at which the advertising message is to be displayed;
a maximum number of occurrences of the advertising messages being displayed;
a minimum time interval between occurrences of the display of the advertising message; and
a level of priority with respect to other advertising messages for arbitrating the order in which a plurality of advertising messages are to be displayed.

69. A method as claimed in claim 67 wherein the message control module extracts from the schedule data an address from which a message file containing the advertising message can be retrieved, and initiates a communications session with the address via the wireless communications system to retrieve the message file.

70. A method as claimed in claim 67 wherein the message control module extracts from the schedule data a further address from which an updated schedule file containing updated schedule data can be retrieved and initiates a communications session with the further address via the wireless communications system to retrieve the updated schedule file, and replaces, the schedule data with the updated schedule data.

71. A method as claimed in claim 66 wherein the communication containing the schedule file address is received via SMS.

72. A method as claimed in claim 66 wherein the communications session for downloading files is via GPRS.

73. A computer program comprising instructions for controlling a portable electronic device to perform the steps of a method, the device comprising:
a user interface; and
an entertainment system operable to output entertainment media signals to the user interface;
the method comprising:
operating a tracking system to generate tracking data comprising at least position data representative of a position of the device;
operating a monitoring system to process the tracking data to obtain monitoring data comprising at least the position data;
operating a wireless communications system to transmit the monitoring data for reception by a control centre and to receive advertising message data representative of an advertisement relevant to a geographical area containing the position of the device as indicated by the position data; and
operating a message control module to process the advertising message data to generate output data for selectively presenting the advertisement via the user interface.

74. A storage medium storing a computer program comprising instructions for controlling a portable electronic device to perform the steps of a method, the device comprising:
a user interface; and
an entertainment system operable to output entertainment media signals to the user interface;
the method comprising:
operating a tracking system to generate tracking data comprising at least position data representative of a position of the device;
operating a monitoring system to process the tracking data to obtain monitoring data comprising at least the position data;
operating a wireless communications system to transmit the monitoring data for reception by a control centre and to receive advertising message data representative of an advertisement relevant to a geographical area containing the position of the device as indicated by the position data; and
operating a message control module to process the advertising message data to generate output data for selectively presenting the advertisement via the user interface.

75. A control system comprising acquiring means for acquiring position data for each of a plurality of portable electronic devices, the position data for each device being representative of the geographical position of the device;
selecting means for selecting those devices for which the position data indicates a position within a defined geographical area; and
transmitting means for transmitting to the selected devices advertisement message data representative of an advertisement relevant to the defined geographical area.

76. A control system as claimed in claim 75 wherein the acquiring means comprises means for sending a message to each of the plurality of devices requesting position data and means for receiving response messages containing the position data.

77. A control system as claimed in claim 76 wherein the position data is derived from global positioning satellite information.

78. A control system as claimed in claim 75 comprising defining means for defining the geographical area to comprise coordinates of a target location of a point of sale and a maximum distance from the target location.

79. A control system as claimed in claim 78 comprising means for generating the advertisement message to include a token redeemable at the point of sale.

80. A control system as claimed in claim 79 wherein the advertisement message comprises a token in the form of a barcode.

81. A control system as claimed in claim 75 comprising means for transmitting map data to the device receiving the advertising message, the map data being representative of a map indicating the target location.

82. A control system as claimed in claim 81 wherein the map data further defines route data representative of a route between the device position and the target location.

83. A control system as claimed in claim 75 comprising second selection means operable to select the plurality of devices from a set of devices by comparing an advertisement profile representative of content of the advertisement with subscriber information in respect of each device in order to select as candidates for receiving the advertising message those devices for which the advertising profile matches the subscriber information.

84. A method of operating a control system comprising the steps of acquiring position data for each of a plurality of portable electronic devices, the position data for each device being representative of the position of the device;
selecting those devices for which the position data indicates a position within a defined geographical area; and
transmitting to the selected devices advertising message data representative of an advertisement relevant to the defined geographical area.

85. A method as claimed in claim 84 wherein the acquiring step comprises sending a message to each of the plurality of devices requesting position data and receiving response messages containing the position data.

86. A method as claimed in claim 85 wherein the position data is derived from global positioning satellite information.

87. A method as claimed in claim 84 comprising defining the geographical area to comprise coordinates of a target location of a point of sale and a maximum distance from the target location.

88. A method as claimed in claim 87 comprising means for generating the advertisement message to include a token redeemable at the point of sale.

89. A method as claimed in claim 88 wherein the advertisement message comprises a token in the form of a barcode.

90. A method as claimed in claim 84 comprising the step of transmitting map data to the device receiving the advertisement message, the map data being representative of a map indicating the target location.

91. A method as claimed in claim 90 wherein the map data further defines route data representative of a route between the device position and the target location.

92. A method as claimed in claim 84 comprising a second selection step of selecting the plurality of devices from a set of devices by comparing an advertisement profile representative of content of the advertisement with subscriber information in respect of each device in order to select as candidates for receiving the advertisement message those devices for which the advertisement profile matches the subscriber information.

93. A method as claimed in claim 84 wherein the control system transmits advertising message data to devices by the steps of:
sending a notification message containing a first address from which a schedule file can be retrieved;
providing the schedule file at the first address, the schedule file comprising a second address at which an advertising message containing the advertising message data can be retrieved in a communications session to be initiated by the device; and
providing the advertising message at the second address for retrieval during a communications session to be initiated by the device.

94. A computer program comprising instructions for controlling a control centre to perform the steps of a method comprising:
receiving monitoring data from a portable electronic device, the monitoring data comprising at least position data representative of the position of the device;
retrieving map data representative of an area corresponding to the position of the device as indicated by the position data;
and transmitting the map data to the device.

95. A storage medium storing a computer program comprising instructions for controlling a control centre to perform the steps of a method comprising:
receiving monitoring data from a portable electronic device, the monitoring data comprising at least position data representative of the position of the device;
retrieving map data representative of an area corresponding to the position of the device as indicated by the position data;
and transmitting the map data to the device.

96. A computer program comprising instructions for controlling a control system to perform a method comprising the steps of acquiring position data for each of a plurality of portable electronic devices, the position data for each device being representative of the position of the device;
selecting those devices for which the position data indicates a position within a defined geographical area; and
transmitting to the selected devices advertising message data representative of an advertisement relevant to the defined geographical area.

97. A storage medium storing a computer program comprising instructions for controlling a control system to perform a method comprising the steps of acquiring position data for each of a plurality of portable electronic devices, the position data for each device being representative of the position of the device;
selecting those devices for which the position data indicates a position within a defined geographical area; and
transmitting to the selected devices advertising message data representative of an advertisement relevant to the defined geographical area.

98. A portable electronic device comprising:
a user interface comprising a display;
an entertainment system operable to output entertainment media signals to the user interface;
a tracking system operable to generate tracking data comprising at least position data representative of a position of the device;
a monitoring system operable to process the tracking data to obtain monitoring data comprising at least the position data;
a wireless communications system operable to transmit the monitoring data for reception by a control centre;
wherein the monitoring system is operable to compare the tracking data with stored configuring data to determine whether an alarm condition exists and wherein the monitoring system is operable to generate the monitoring data to comprise alarm data representative of the status of at least one alarm condition.

99. A portable electronic device comprising:
a user interface comprising a display;
an entertainment system operable to output entertainment media signals to the user interface;
a tracking system operable to generate tracking data comprising at least position data representative of a position of the device;
a monitoring system operable to process the tracking data to obtain monitoring data comprising at least the position data;
a wireless communications system operable to transmit the monitoring data for reception by a control centre; and
routing means responsive to user input via the user interface to generate a request message for requesting route data defining a route between the current position of the device and a specified location;
the wireless communications system being operable to transmit the request message to the control centre and to receive a response message containing the route data for display by the user interface.
